(19) United States
(12) Patent Application Publication
(10) Pub. No.: US 2008/0002625 A1
(43) Pub. Date: Jan. 3, 2008

(54) Bridged portable internet system and method for processing signal thereof

(75) Inventors: Jae-Hun Cho, Seoul (KR); Seong-Taek Hwang, Pyeongtaek-si (KR); Jong-Ho Yoon, Goyang-si (KR); Yun-Je Oh, Yongin-si (KR); Hoon Kim, Suwon-si (KR); Han-Kyun Jung, Goyang-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/644,575

(22) Filed: Dec. 22, 2006

(30) Foreign Application Priority Data
Jun. 30, 2006 (KR) 60848/2006

(51) Int. Cl. H04Q 7/00

(52) U.S. Cl. 370/331

(57) ABSTRACT

Disclosed is a bridged portable internet system, which includes: a plurality of edge bridges entirely connected as a mesh structure to form a core network, and configured as a layer 2 switch; a plurality of Radio Access Stations (RASs) connected to one of the plurality of edge bridges to provide portable internet services to Mobile Nodes (MNs) within the range of services; and a Neighbor Discovery Server (NDS) for supporting neighbor discovery of components in the network and storing and managing configuration information of the components, wherein each of the plurality of edge bridges maintains an optimal path through a predetermined routing protocol, identifies the destination of a Media Access Control (MAC) frame transmitted by an MN connected to an edge bridge itself through a corresponding RAS by referring to the configuration information from the NDS so as to transmit a corresponding MAC frame to the MAC address of an edge bridge to which a corresponding CN is connected by performing MAC in MAC encapsulation if receiving a MAC in MAC encapsulated frame with its own MAC address as a destination, and performs MAC in MAC encapsulation with the frame to delete an outer MAC address and to transmit an original MAC frame to a corresponding MN.

### CLAIM OF PRIORITY

This application claims priority to an application entitled “Bridged Portable Internet System and Method for Processing Signal Thereof,” filed with the Korean Intellectual Property Office on Jun. 30, 2006 and assigned Ser. No. 2006-60848, the entire contents of which are incorporated herein by reference.

### BACKGROUND OF THE INVENTION

1. Field of the Invention

The present invention relates to a portable internet network, and more particularly to a bridged portable internet system to facilitate management and enable fast handover services by performing a simple and effective signaling process, and a method for processing a signal of the bridged portable internet system.

2. Description of the Related Art

Current portable internet technology has merged third and fourth generation cellular systems based on a portable telephone network and Portable Internet (PI) or Wireless Broadband (WiBro) systems based on Internet Protocol (IP)-based packet transmission together. Further, there have been suggested various standard plans for maximizing efficiency of use with ultra high-speed data communication technology.

FIG. 1 is a view showing a configuration of a Fast Mobile IPv6 network, and FIG. 2 is a flow diagram illustrating an example of a handover process in the network of FIG. 1. The Fast Mobile IPv6 shown in FIGS. 1 and 2 is a protocol suggested to minimize a handover delay in existing Mobile IPv6.

First, the definitions of terms used in the Fast Mobile IPv6 are discussed as follows. Mobile Node (MN) is a mobile node for supporting IPv6 and Access Point (AP) is layer 2 equipment connected to an IP subnet to provide wireless connection to an MN. AP-ID means the layer 2 address of an AP.

An Access Router (AR) is a basic router to which an MN is connected, Previous Access Router (PAR) means an AR to which the MN has been connected before performing a handover, and New Access Router (NAR) means an AR to which the MN is connected after performing the handover.

Previous CoA (PcoA) means a Care of Address (CoA) that an MN has used in the subnet of a PAR, and New CoA (NCoA) means a CoA that the MN will use in the subnet of an NAR.

Router Solicitation for Proxy Advertisement (RtSolPr) means a message that an MN transmits to a PAR so as to obtain information related to neighboring APs before performing a handover, and Proxy Router Advertisement (PrRtAdv) means a message that the PAR transmits to the MN in response to the RtSolPr. Information on neighboring APs is contained in the response message PrRtAdv. In a case of a Network-initiated handover, the PrRtAdv is immediately transmitted by the MN without first receiving the RtSolPr message.

AP-ID and AR-Info tuple respectively are the layer 2 ID and IP addresses of an AR to which an AP with the AP-ID is connected, and contain valid prefix information. The AR-info is configured as [Router's L2 address, Router's IP address, Prefix].

“Assigned Addressing” is a specific type of NCoA setting in which an NAR assigns an IPv6 address to an MN.

Fast Binding Update (FBU) is a message that an MN transmits to a PAR, and instructs a packet transmitted to the PAR itself to be forwarded to an NAR. Fast Binding Acknowledgement (FBack) is a message that the PAR transmits to the MN in response to the FBU. Fast Neighbor Advertisement (FNA) is a message in which an MN informs an NAR that the MN itself is connected thereto. Handover Initiate (HI) is a message in which a PAR informs an NAR of the handover of an MN, and Handover Acknowledge (HAck) is a message that the NAR transmits to the PAR in response to the HI.

Referring back to FIG. 1, FIG. 1 illustrates a state in which ARs 103 and 104 comprising a plurality of subnets are connected to a core IP network 10 comprising a plurality of routers 101 and 102, and illustrates an example in which an MN 115 performs a handover from a PAR 103 to an NAR 104.

A handover process in this case is now described in detail with reference to FIG. 2. First, the MN requests information on one or more APs retrieved in a layer 2 by transmitting RtSolPr to the PAR to which the MN is currently connected (step 201). The PAR, having received the RtSolPr, sends a PrRtAdv message containing {AP-ID, AR-Info} to the corresponding MN (step 202). At this time, the respective ARs may periodically exchange information of APs connected to the ARs, and the like.

The MN, having received the PrRtAdv, sets a new NCoA usable in an AP to which the MN will be newly connected through {AP-ID, AR-Info} information (step 203). Thereafter, if a real handover event occurs in the layer 2, the MN sends an FBU message to the PAR (step 204). Since NCoA information is contained in the FBU, the PAR, having received the FBU, stores binding information of NCaA and PCoA, and forwards packets proceeding to the MN to the NAR through a tunnel formed with the NAR using the binding information (steps 209, 210 and 211). At this time, if possible, it is preferred that the FBU be transmitted when the MN is connected to the PAR. If impossible, the FBU is transmitted after the MN has been connected to the NAR. Thereafter, the PAR transmits FBack to the MN in response to the FBU (step 207).

There are two operation modes depending on a time point when the FBack is received by the MN (when the MN is connected to the PAR or the NAR). First, in a case where the MN receives the FBack when it is connected to the PAR, this means that the tunnel has already been generated after the MN is connected to the NAR. The MN transmits FNA to the NAR immediately after the MN is connected to the NAR so as to receive packets buffered in the NAR (steps 212 and 214). Thereafter, the MN transmits binding update information to a HA/CN, and the HA/CN receives the binding update information to transmit response information thereon and to update binding information (steps 215 and 216).

If the PAR receives the FBU in this operation mode, the PAR sends an HI message to the NAR in order to identify whether or not the NCoA (produced by the MN) contained in the FBU is usable in the NAR (step 205). If the NCoA produced by the MN has already been used, the NAR produces a new NCoA to transmit to the PAR through a HAck message (step 206), and the PAR contains the new NCoA in the FBack to send it to the MN (step 207). The MN, having received the FBack in which the new NCoA is contained, should use the new NCoA after being connected to the NAR. If the NCoA produced by the MN is usable in the NAR, the NCoA is not contained in the HAck and FBack messages.

FIG. 3 is a flow diagram illustrating another example of a handover process in the network of FIG. 1. Similar to the handover process of FIG. 2, FIG. 3 illustrates a case where the MN does not receive FBack from the PAR after performing a process in which the MN transmits RtSolPr to the PAR to which the MN is currently connected (step 301), receives a PrRtAdv message from the PAR that received the RtSolPr (step 302), and sets a new NCoA usable in an AP to which the MN will be newly connected (step 303). This case is a case where the MN does not transmit FBU when being connected to the PAR, or where a handover occurs before FBack is received although the MN has transmitted the FBU.

Since the MN, not having received the FBack, does not identify whether or not the PAR processes the FBU, the MN again (or first) transmits the FBU to the NAR immediately after the MN is connected to the NAR (step 305). At this time, the FBU is transmitted while being contained in FNA in order to allow the NAR to transmit packets immediately after the FBU is processed, and to allow the NAR to determine whether or not the NCoA is usable. The NAR, having received the FNA, checks whether or not the NCoA contained in the FBU is usable (step 306). If a corresponding address has been already used, the NAR discards corresponding packets and then sends the message “Router Advertisement” containing option “Neighbor Advertisement Acknowledge (NAACK)” to the MN (step 307). The message contains NCoA that the MN should use.

Accordingly, the MN transmits a new FBU to the NAR using a newly assigned NCoA (steps 308, 309 and 310), and the NAR transmits the received FBU to the PAR (step 311). Thereafter, the PAR sends an FBack message to the NAR (step 312). Accordingly, packets transmitted to the PAR are forwarded to the NAR (steps 313 and 314) and the NAR forwards the corresponding packets to the MN (step 315). Thereafter, corresponding binding information is updated to the HA/CN (steps 316 and 317).

Meanwhile, Mobile Ethernet is a protocol for supporting a faster handover by replacing an existing IP network with a layer 2 switch. In order to deal with expandability that becomes a problem due to conversion of a layer 3 into a layer 2, the Mobile Ethernet has the following features:
Path-learning Layer 2 Switch
Learning cache dynamic renewal signaling mechanism
Broadcast control mechanism (e.g., ICMPv6 neighbor solicitation)
Network partitioning: Segment

Further, Virtual Media Access Control (MAC) is assigned to each terminal to switch using only the corresponding Virtual MAC in a mobile Ethernet network so that different wireless access networks can be linked to each other.

FIG. 4 illustrates an example of a configuration of a mobile Ethernet network. A core network 21 is connected in the shape of a ring, and segments 22, 23 and 24 are configured in the shape of a tree. Components included in the network are as follows: a gate switch 211 is a switch for connecting the segments 22, 23 and 24 and the core network 21, and edge switches 242 and 243 are switches for connecting the segments 22, 23 and 24 and different networks (access networks) 30, 31 and 32. A branch switch 241 is a switch between the edge switches 243 and 242 and the gate switch 211.

A handover in such a mobile Ethernet network is divided into an intra-segment handover, which is accomplished when a terminal moves within a segment, and an inter-segment handover, which is accomplished when a terminal moves between segments.

FIG. 5 illustrates a flow diagram of an example of a handover process in the network of FIG. 4. A process of an inter-segment handover is illustrated as an example in FIG. 5. The handover process in the mobile Ethernet network is started by a signaling server. The signaling server determines the need for a handover of a mobile terminal (MD). If it is determined that the handover is needed, the signaling server sends the message “H/O recommendation” to a Previous Edge Switch (PES) to which the MD is currently connected (step 501). The PES, having received the message, sends information of the MD and the like to a New Edge Switch (NES) (steps 502 and 503), and then sends the message “H/O recommendation” to the MD, for example, through a corresponding AP (Previous AP) (step 504). Thereafter, the MD establishes a link with a new AP (steps 506 and 507), and then sends the message “Registration Request” to the NES to register the RMAC and VMAC of the MD (steps 508 and 509).

In order to allow a frame proceeding to the MD to be sent to the NES, the NES sends the message “Update Entry Request” to an upper switch to update the FDB of the upper switch (step 510). The process is repeated up to an anchor switch (a rendezvous point on a path from the NES to a segment gateway switch and a path from the PES to the segment gateway switch), and the anchor switch updates its own FDB and then sends the message “Cancel Entry Request” toward the PES to delete FDB for the corresponding MD (step 513).

Next, an intra-segment handover in the mobile Ethernet network is discussed. In a case where the MD moves to another segment, a segment gateway switch of the new segment receives the message “Update Entry Request” from an edge switch. The new segment gateway switch, having received the message, sends the message “Update Entry Request” to the previous segment gateway switch, and the switch having received the message sends the message “Cancel Entry Request” to a lower switch of the segment in which the switch exists. The message is sent up to the previous edge switch such that information on the corresponding MD is deleted in the FDB of each switch.

Such a message “Update Entry Request” and a MAC frame proceeding to the MD are sent through the following three schemes.

First, in a broadcast scheme, a message “Update Entry Request,” which is sent to the new segment gateway switch after the MD has moved, is sent to the previous segment gateway switch within the core network ring. Another segment gateway switch receiving the message within the ring does not update its own FDB. That is, the MAC address of the corresponding MD is not learned. Although the previous segment gateway switch sends a message “Cancel Entry Request,” to its own lower switch to delete the FDB, the MAC address of the corresponding MD is also not learned. Thereafter, since an arbitrary segment gateway switch receiving a MAC frame from the corresponding MD does not learn the MAC address of the corresponding MD, it broadcasts the MAC frame within the ring core network. The frame is transmitted along the ring, and segment gateway switches receiving the frame discard it if there is no information of the corresponding MD in their own FDB, and send it to their segments if there is information of the corresponding MD in their own FDB.

Next, in a MAC learning scheme, a message “Update Entry Request,” which is sent to the new segment gateway switch after the MD has moved, is sent along the ring, and all the segment gateway switches learn the MAC address of the corresponding MD. Thus, a MAC frame from the MD can be always sent along an optimal path.

In an anchor scheme, only a home segment gateway switch learns the current position of the MD. A new segment gateway switch, receiving the message “Update Entry Request” after the MD has moved, sends the corresponding message to the home segment gateway switch, and the home segment gateway switch learns the MAC address of the corresponding MD. Thereafter, a MAC frame proceeding to the MD is first transmitted to the home segment gateway switch and then transmitted again to the new segment gateway switch.

In the conventional technology as described above, although the Fast Mobile IPv6 reduces a handover delay of the existing Mobile IPv6 at a minimum, there exists a problem in that a new IP should be assigned whenever moving between ARs due to the intrinsic attribute of an IP layer handover protocol. Accordingly, there is required the exchange and delay of specific signaling packets. Particularly, in a case where NCoA set by a mobile terminal is not valid in a reactive handover, additional signaling packets are required to assign a new NCoA. Accordingly, delay time is increased.

First, in the mobile Ethernet, there is a disadvantage in that a frame is not transmitted through an optimal path due to features of a network configured in the shape of a tree in communication of two mobile terminals within a segment even though the number of signaling packets required in an intra-segment handover is small and thus, a handover delay is considerably short. Further, since a frame is transmitted along a ring in a core network configured in the shape of a ring, the frame is not transmitted through an optimal path. Furthermore, there is a disadvantage in that a frame is not transmitted through an optimal path in a ring within a core network in a case of the broadcast scheme, and there is a problem in that each segment gateway switch should learn the MAC addresses of all the mobile terminals in a case of the MAC learning scheme. In addition, although data in a ring may be transmitted in a fast direction, it is unreasonable that it is an optimal path due to a characteristic of a ring. Moreover, there are many difficulties in connecting a considerably broad service area with a ring network.

### SUMMARY OF THE INVENTION

Accordingly, the present invention provides a bridged portable internet system and a method for processing a signal thereof, which provides an effective and fast handover by a simple and effective signaling process that employs a layer 2 bridge in a next-generation wireless edge network.

According to an aspect of the present invention, there is provided a bridged portable internet system, which includes: a plurality of edge bridges entirely connected as a mesh structure to form a core network, and configured as a layer 2 switch; a plurality of Radio Access Stations (RASs) connected to one of the plurality of edge bridges to provide portable internet services to Mobile Nodes (MNs) within the range of services; and a Neighbor Discovery Server (NDS) for supporting neighbor discovery of components in the network and managing configuration information of the components, wherein each in the plurality of edge bridges maintains an optimal path through a predetermined routing protocol, identifies the destination of a Media Access Control (MAC) frame transmitted by an MN connected to an edge bridge itself through a corresponding RAS by referring to the configuration information from the NDS so as to transmit a corresponding MAC frame to the MAC address of an edge bridge to which a corresponding CN is connected by performing MAC in MAC encapsulation if receiving a MAC in MAC encapsulated frame with its own MAC address as a destination, and performs MAC in MAC encapsulation with the frame to delete an outer MAC address and to transmit an original MAC frame to a corresponding MN.

### BRIEF DESCRIPTION OF THE DRAWINGS

The above and other features and advantages of the present invention will be more apparent from the following detailed description taken in conjunction with the accompanying drawings, in which:

FIG. 1 illustrates an example of a configuration of a Fast Mobile IPv6 network;

FIG. 2 illustrates an example of a flow diagram of a handover process in the network of FIG. 1;

FIG. 3 illustrates a flow diagram of another example of a handover process in the network of FIG. 1;

FIG. 4 illustrates an example of a configuration of a mobile Ethernet network;

FIG. 5 illustrates a flow diagram of an example of a handover process in the network of FIG. 4;

FIG. 6 illustrates an example of a configuration of a bridged portable internet network according to an embodiment of the present invention;

FIG. 7 illustrates an example of a flow diagram of a registration process of a mobile terminal in the network of FIG. 6;

FIGS. 8a and 8b illustrate examples of flow diagrams of a data transmission process in the network of FIG. 6; and

FIGS. 9a and 9b illustrate examples of flow diagrams of a handover process in the network of FIG. 6.

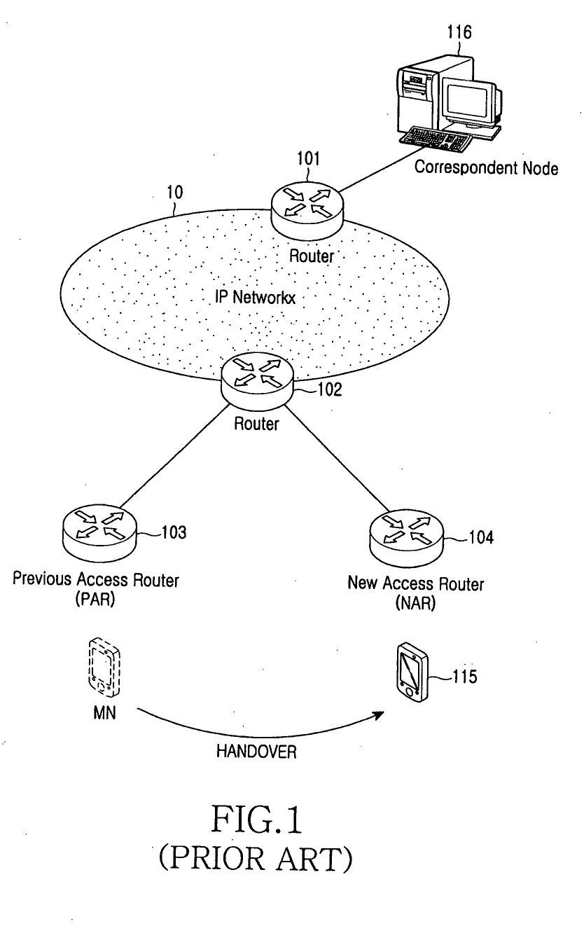

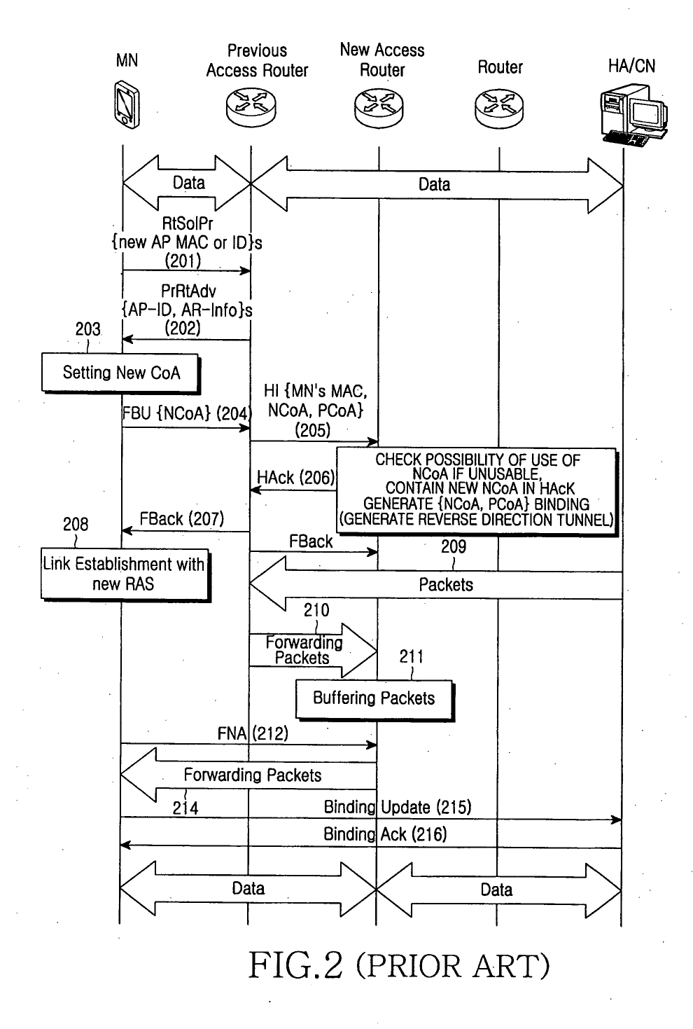

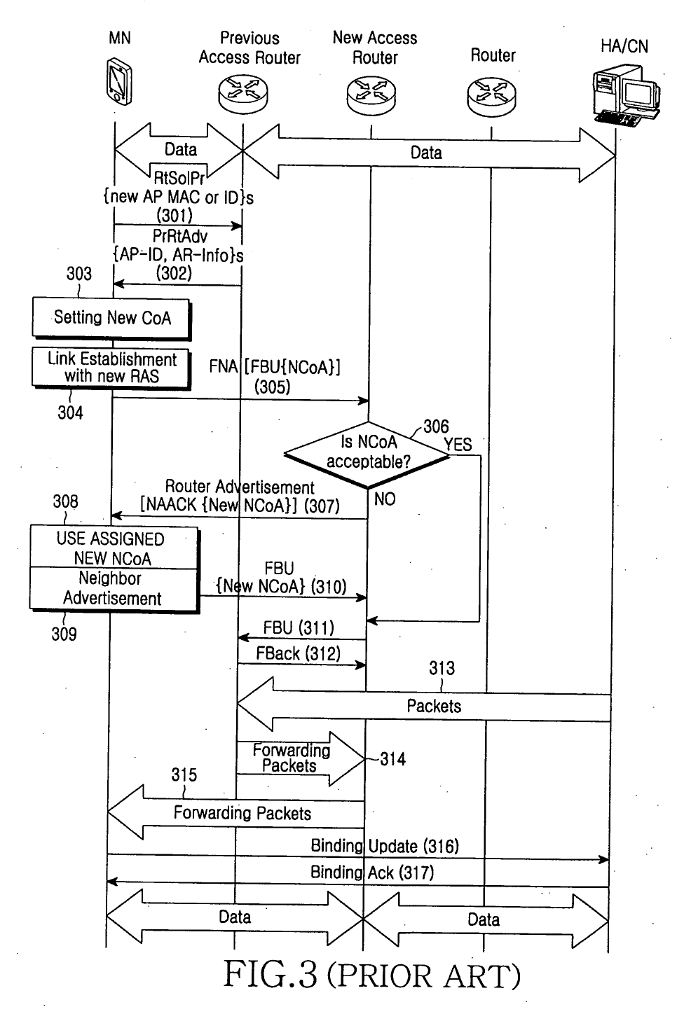

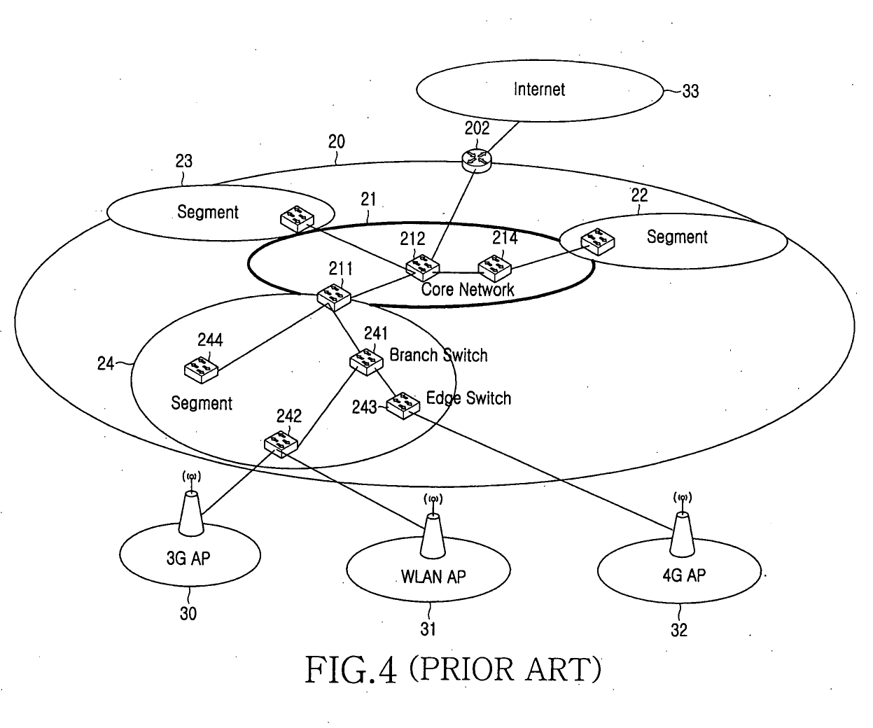

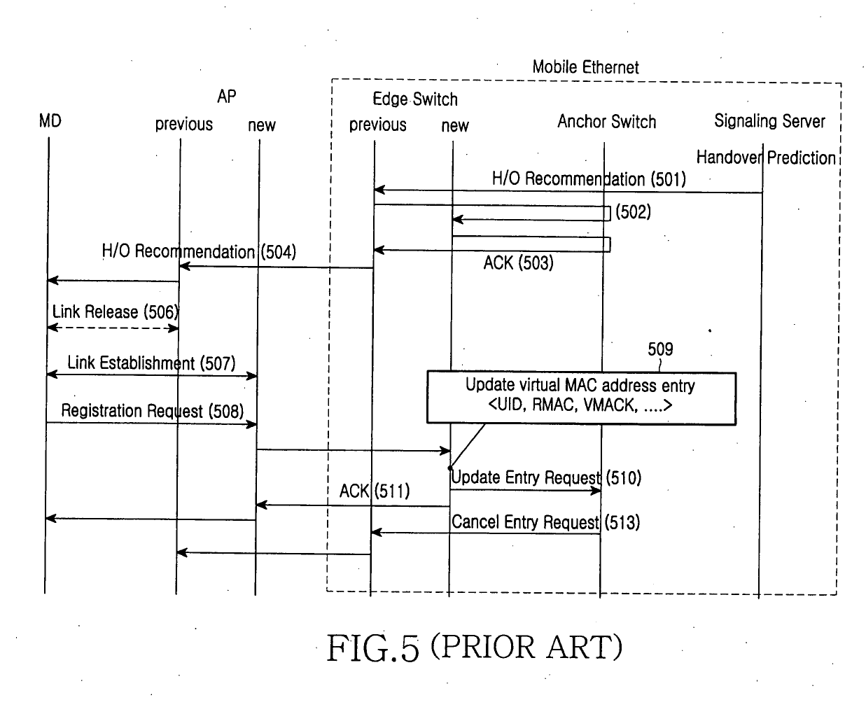

### DETAILED DESCRIPTION

Hereinafter, embodiments of the present invention are described with reference to the accompanying drawings. In the following description, the same elements are designated by the same reference numerals although they are shown in different drawings. For the purposes of clarity and simplicity, a detailed description of known functions and configurations incorporated herein is omitted as it may make the subject matter of the present invention rather unclear.

In general, Ethernet is one of many technologies that can be easily accessed when transmitting data between different terminals or many users. Such a layer 2 Ethernet technology has been under discussion on the expansion of its area from LAN to WAN/MAN owing to its success. In a WiBro network representing next-generation wireless communication network as an example, the present invention enables a service area covered by existing equipment of layer 3 or more to be served in layer 2 so that management can be facilitated and fast handover service is possible.

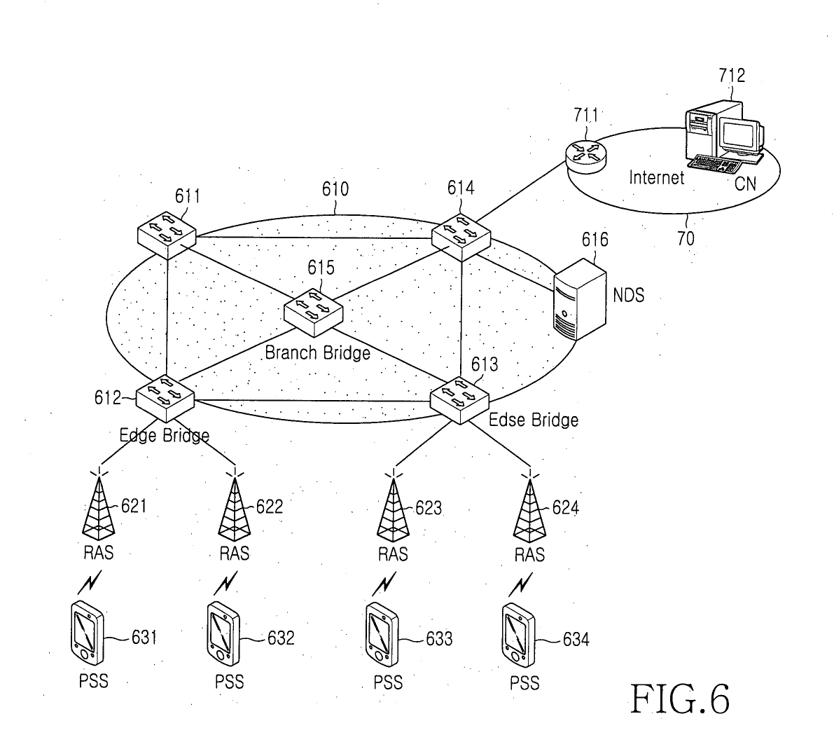

FIG. 6 illustrates a configuration of a bridged portable internet network, according to an embodiment of the present invention. Referring to FIG. 6, the network according to the present invention is connected in a mesh structure to form a core network. Further, the network includes: edge bridges 611, 612, 613 and 614 and a branch bridge 615, each of which are configured as layer 2 switches; a plurality of Radio Access Stations (RASs) 621, 622, 623 and 624 appropriately connected to one of the plurality of edge bridges 611, 612, 613 and 614 to provide portable internet services to Mobile Nodes (MNs) within the range of services; a Neighbor Discovery Server (NDS) 616 for supporting the neighbor discovery of all network components and for managing configuration information thereof. The respective MNs (PSS) 631, 632, 633 and 634 are appropriately connected to the corresponding RASs 621, 622, 623 and 624. As an example, a state where the fourth edge bridge 614 is connected to a Correspondent Node CN 712 through a router 711 on the Internet 70 is illustrated in the network of FIG. 6.

In the present invention, a handover faster than Fast Mobile IPv6 is supported, and a new protocol is provided that is capable of solving all the problems of an optimal path, which are problems in Mobile Ethernet. To this end, the entire network is configured such that layer 2 switches are connected in the shape of a mesh as shown in FIG. 6, and each of the bridges 611 to 615 always maintains an optimal path to a specific bridge through a protocol similar to a routing protocol such as IS-IS. Thus, all the Media Access Control (MAC) frames are always transmitted to their destinations via optimal paths within the network. Further, each of the edge bridges 611 to 614 transmit the MAC frame transmitted by a terminal connected to the edge bridge itself by performing MAC in MAC encapsulation. At the time, each of the edge bridges 611 to 614 searches the Destination Address (DA) area of the MAC frame to set the DA area of a new MAC in MAC frame header as the ID (MAC address) of the edge bridge to which a corresponding CN is connected. All the branch switches within the mesh network search the DA area of an outer MAC to switch frames. The edge bridge, having received the MAC in MAC frame having its own ID as an outer DA, deletes the outer MAC and transmits the original MAC frame to the corresponding terminal. Further, an NDS 616 of the Mobile Ethernet is used for expandability in a resilient bridge WiBro network according to the present invention.

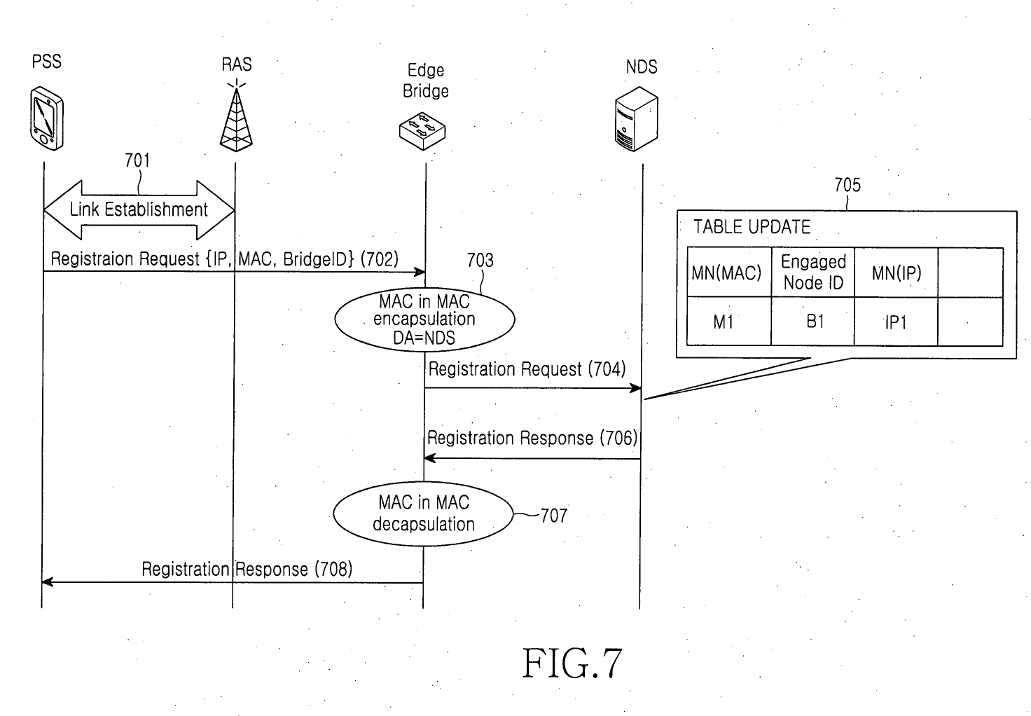

FIG. 7 illustrates a flow diagram of a registration process of a mobile terminal in the network of FIG. 6. In the present invention, a mobile terminal (PSS) sends a registration request message to an NDS to register the ID of a bridge connected to its own MAC address and its own IP address in the initial connection to an RAS as shown in FIG. 7. The NDS maintains a table of such registration information. Each table entry has a lifetime, and is maintained in an active state through a periodic registration message before it expires.

The detailed operation is now discussed with reference to FIG. 7. In a state where a link between a PSS and an RAS is formed (step 701), the PSS first sends a registration request message to a corresponding edge bridge connected thereto through the corresponding RAS (step 702). Accordingly, the corresponding edge bridge performs MAC in MAC encapsulation with the frame destination address of the registration request message as the NDS to transmit it to the NDS (step 703), and the frame destination address is finally transmitted to the NDS via another edge bridge within the mesh network (step 704). Accordingly, the NDS stores (and updates) the MAC address of the corresponding PSS, the ID of the corresponding relative edge bridge and the IP address of the corresponding PSS (step 705). Thereafter, in order to inform that a registration is successfully accomplished, the NDS sends a registration response message (e.g., ICMPv6 Neighbor Advertisement message) to the PSS through the edge bridge (step 706), and the corresponding edge bridge performs MAC in MAC encapsulation with the frame of the registration response message (step 707), and then transmits it to the corresponding PSS (step 708).

At this time, the registration request message may be message “ICMPv6 Neighbor Solicitation” for detecting a duplicated address. Since message “ICMPv6 Neighbor Solicitation” originally has a broadcasting address, it is sent to the entire network. In order to prevent this, an edge bridge adds a new MAC header to the corresponding message (MAC in MAC encapsulation) to set a DA area as the MAC address of the NDS and then transmits it. Branch bridges identify only the outer MAC DA of the frame to switch the flame. Further, the NDS recognizes and generates a MAC in the MAC frame.

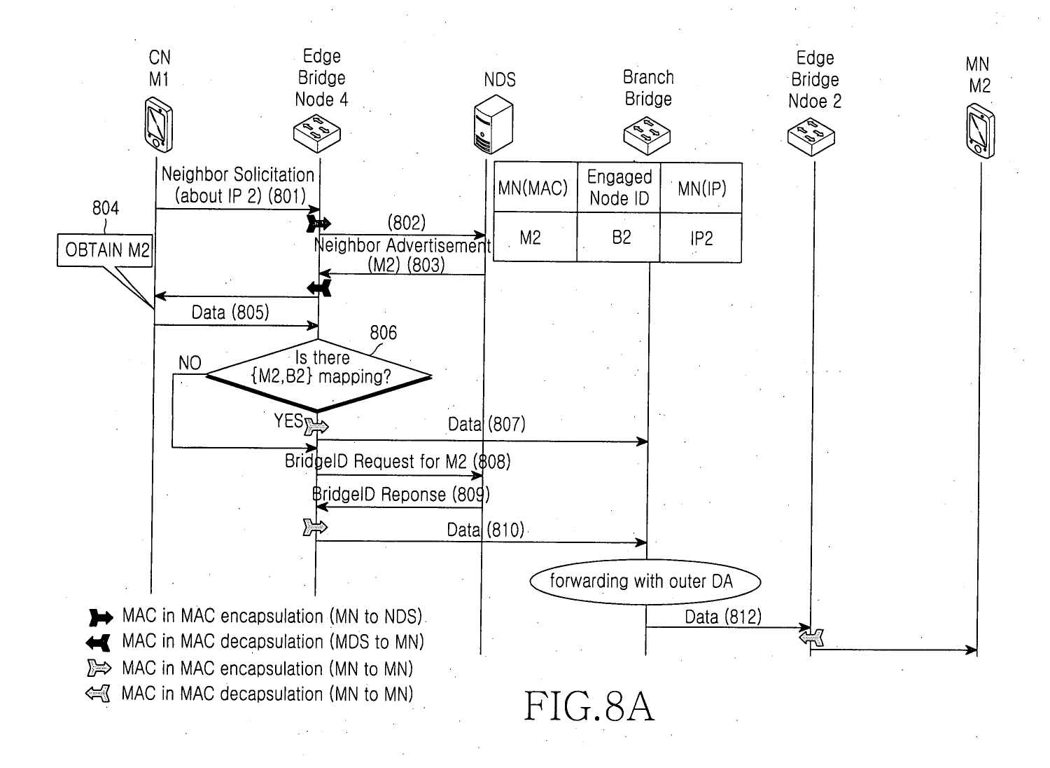

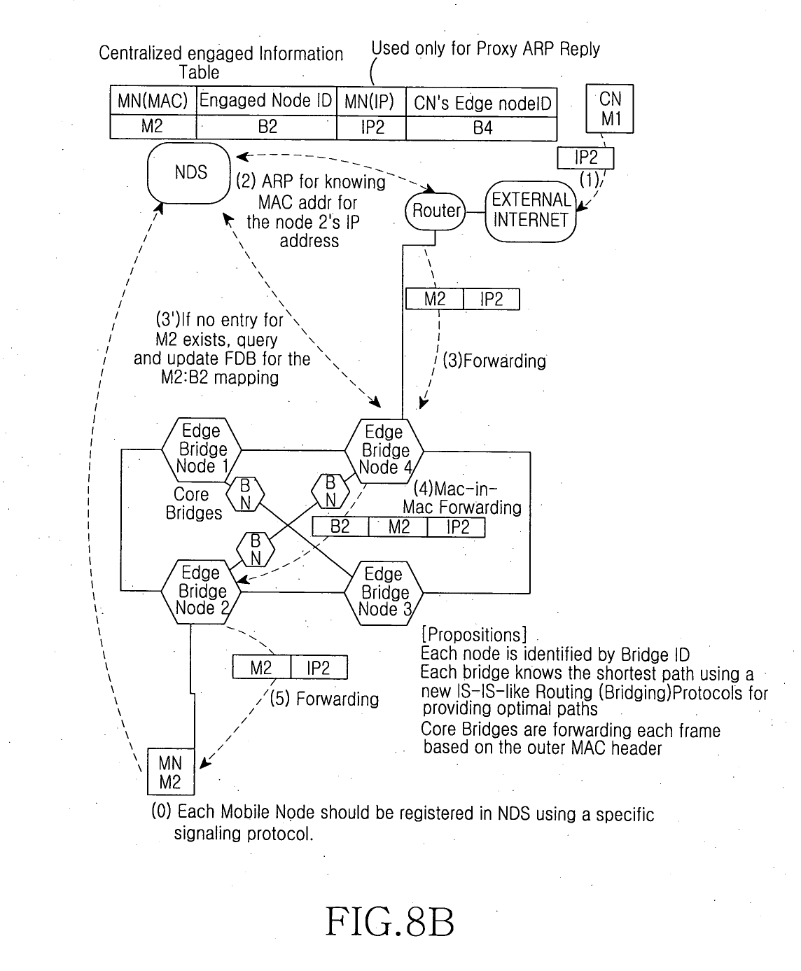

FIGS. 8a and 8b illustrate examples of flow diagrams of a data transmission process in the network of FIG. 6. FIG. 8a illustrates an example of the data transmission process in accordance with a temporal flow of message transmission, and FIG. 8b illustrates an example of the data transmission process on a network configuration view. Further, a mobile terminal (CN) transmitting data is connected to a fourth edge bridge and a state where an MN is connected through a second edge bridge is illustrated as an example in FIGS. 8a and 8b.

Referring to FIG. 8a, first, a CN intending to transmit data sends the message “Neighbor Solicitation” to the NDS through a corresponding edge bridge (i.e., the fourth edge bridge) so as to obtain the MAC address (M2) of an MN at a destination (steps 801 and 802). Accordingly, the NDS retrieves the MAC address (M2) of the MN to send the message “Neighbor Advertisement” to the corresponding CN (steps 803 and 804). The CN, having obtained the MAC address (M2) of the MN through message “Neighbor Advertisement,” transmits a frame (steps 804 and 805), and an edge bridge (e.g., the fourth edge bridge) having received the frame performs MAC in MAC encapsulation of the corresponding frame to the ID of the edge bridge through which the MN is connected.

That is, each edge bridge maintains the MAC address of each MN and a BridgeID binding table as a soft state. An edge bridge, having received a MAC frame that will be transmitted to a specific MN, identifies the BridgeID of the corresponding MN in its own table (step 806). If the BridgeID of the corresponding MN exists in its own table, the edge bridge immediately performs MAC in MAC encapsulation with the corresponding BridgeID to transmit it (step 807). Unless the BridgeID of the corresponding MN exists in its own table, the edge bridge sends a BridgeID request message to the NDS (step 808) to obtain the BridgeID of the corresponding MN (step 809), and then performs MAC in MAC encapsulation with a frame to transmit it (step 810). The frame transmitted by being MAC in MAC encapsulated is forwarded the edge bridge (e.g. the second edge bridge) of the corresponding destination MN (step 812), and is MAC in MAC decapsulated at the corresponding edge bridge.

FIG. 8b illustrates a state where a CN transmitting data is connected to the fourth edge bridge through a router of an external internet as an example. Referring to FIG. 8b, if the CN transmits data to the IP address (IP2) of a destination MN (process 1), the corresponding router obtains the MAC address (M2) of the corresponding destination MN from the NDS through a process that follows Address Resolution Protocol (ARP) (process 2). Thereafter, the destination address (M2) of the MN is added to the header of a corresponding frame to forward the frame to a corresponding edge bridge (i.e., the fourth edge bridge) connected thereto (process 3). The edge bridge (i.e., fourth edge bridge) connected to the router receives the frame to perform MAC in MAC encapsulation of the corresponding frame with the ID (B2) of the edge bridge to which the corresponding MN is connected. At this time, the corresponding edge bridge identifies the BridgeID (B2) of a corresponding MN, which will be transmitted to its own table. If the BridgeID (B2) exists in its own table, the corresponding edge bridge immediately performs MAC in MAC encapsulation with the corresponding BridgeID (B2) to transmit it (process 4). Unless the BridgeID (B2) exists in its own table, the corresponding edge bridge sends a BridgeID request message to the NDS to obtain the BridgeID of the corresponding MN (process 3), and then performs MAC in MAC encapsulation of a frame to transmit it (process 4). The frame, transmitted by being subjected to the MAC in MAC encapsulation in such a manner, is forwarded to an edge bridge (e.g., the second edge bridge) of the corresponding destination MN (process 4), and is MAC in MAC decapsulated to be provided to the MN (process 5).

In a case where a router obtains the MAC address (M2) of a corresponding destination MN from the NDS in the data transmission as described above, the NDS stores the BridgeID (B4) of an edge router (i.e., the fourth edge router) to which the corresponding router will be connected as the ID of an edge router of the CN for the MN in a table. In a case where the corresponding MN performs a handover after the BridgeID (B4) has been stored in the table in such a manner, the BridgeID (B4) can be functionally used.

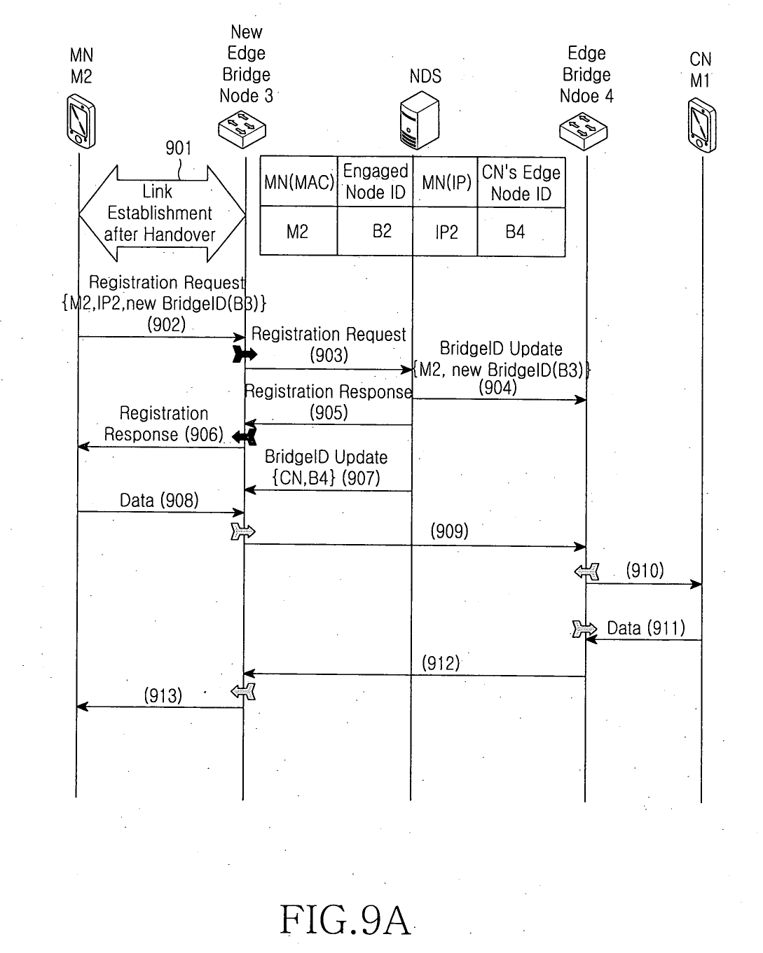

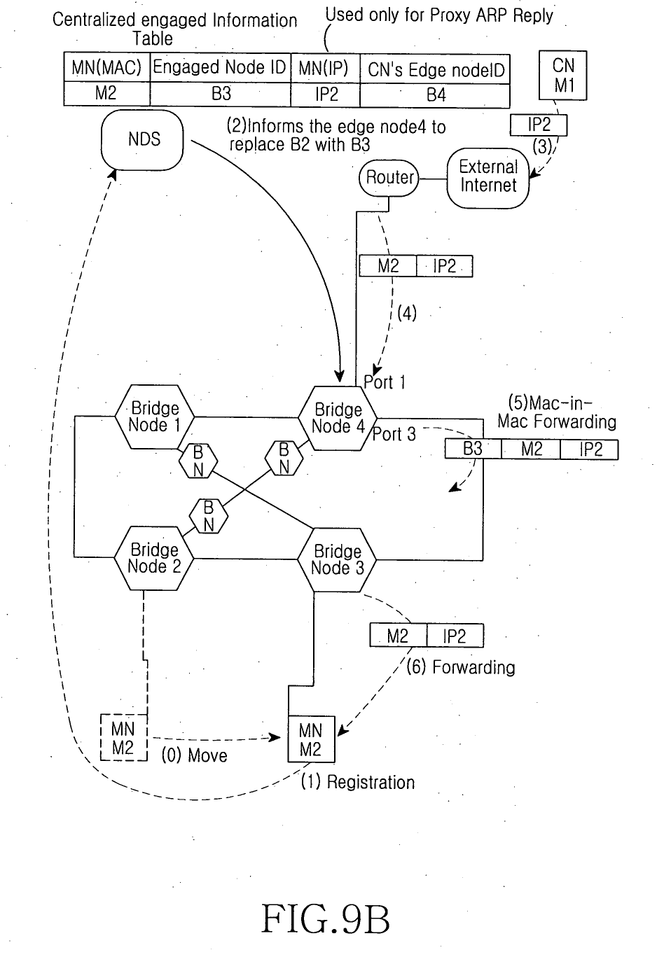

FIGS. 9a and 9b illustrate examples of flow diagrams of a handover process in the network of FIG. 6. FIG. 9a illustrates the handover process in accordance with a temporal flow of message transmission, and FIG. 9b illustrates the handover process on a network configuration view. Further, a mobile terminal (MN) performing a handover is connected to the second edge bridge, and a state where a CN is connected through the fourth edge bridge is illustrated as an example in FIGS. 9a and 9b.

Referring to FIGS. 9a and 9b, the NDS first receives a BridgeID request message sent by each edge bridge to previously store a BridgeID list of the CN for a specific MN in the data transmission process shown in FIGS. 8a and 8b. In such a state, the MN, for example, moving (performing a handover) from the second edge bridge to the third edge bridge, forms a link with the third edge bridge (step 901 of FIG. 9a and process 0 of FIG. 9b), sends a registration request message to the NDS through the third edge bridge to register a new BridgeID (B3) connected to the MN itself (steps 902 and 903 of FIG. 9a and process 1 of FIG. 9b). Accordingly, the NDS sends an update message containing the BridgeID (B3) of a new edge bridge of the MN to an edge bridge (i.e., the fourth edge bridge) corresponding to the BridgeIDs (B4) of CNs having been previously stored in a list of the corresponding MN within the table (step 904 of FIG. 9a and process 2 of FIG. 9b) such that the edge bridge (the fourth edge bridge) can immediately perform MAC in MAC encapsulation to the new edge bridge (the third edge bridge). The NDS sends a registration response message to the MN through the third edge bridge (steps 905 and 906 of FIG. 9a). Further, the NDS sends a BridgeID update message containing the BridgeID of the CN to the new edge bridge (the third edge bridge) of the corresponding MN such that the corresponding edge bridge can immediately perform MAC in MAC encapsulation (step 907 of FIG. 9a). If the MN transmits data in such a state (step 908 of FIG. 9a), the data is transmitted to the fourth edge bridge via the third edge bridge, and is then transmitted to the CN (steps 909 and 910 of FIG. 9a). Further, if the CN transmits data to the MN (step 911 of FIG. 9a and processes 3 and 4 of FIG. 9b), the data is transmitted to the third edge bridge via the fourth edge bridge, and is then transmitted to the MN (steps 912 and 913 of FIG. 9a and processes 5 and 6 of FIG. 9b).

The numbers of signaling packets of Fast Mobile IPv6 (FMIPv6) which is an existing handover protocol, Mobile Ethernet, and a protocol according to the present invention, are as shown in the following Table 1.

TABLE 1

| | FMIPv6 | Mobile Ethernet | Proposal |
|---|---|---|---|
| Signaling | Router Solicitation for Proxy | H/O | Registration |
| Packets | Advertisement | | |
| per | Proxy Router Advertisement | Recommendation | Request |
| handover | Fast Binding Update | Context Transfer | Registration |
| | Fast Binding Acknowledgement | Context Transfer | Response |
| | Handover Initiate | Ack | BridgeID update |
| | Handover Acknowledgement | Registration | (to MN's bridge) |
| | Binding Update | Request | BridgeID update |
| | Binding Acknowledgement | Registration | (to CN's bridge) |
| | (Neighbor Advertisement | Acknowledgement | (Context Transfer) |
| | Acknowledgement) | Update Entry | (Context Transfer |
| | (Neighbor | Cancel Entry | Ack) |
| | Advertisement)(broadcast) | | |
| Total | 9 or 11 | 7 | 4 or 6 |

Referring to Table 1, in a case of the Fast Mobile IPv6, there is required the exchange of 9 signaling packets in a basic condition. If NCoA generated by a terminal is not valid in a case of operating in a reactive mode, there is required the exchange of 11 signaling packets. At this time, one of them is a broadcast message. Further, the number of binding update messages is in proportion to that of CNs.

In a case of the Mobile Ethernet, there is required the exchange of 7 signaling packets, and it is constant regardless of the number of CNs. However, since the message “Update Entry Request” is sent to all the segment gate switches along a ring in a case of an inter-segment handover, a large number of network resources are consumed. Further, other signaling packets except binding update and binding response messages are exchanged only among a PAR, an NAR and an MN in the Fast Mobile IPv6. On the other hand, signaling packets of the Mobile Ethernet requires a great deal of round-trip time, and the number of “Update Entry” and “Cancel Entry” messages is increased in the inter-segment handover.

The protocol according to the present invention requires the exchange of signaling packets, i.e., 4 to 6 signaling packets, less than those in the two existing schemes as shown in Table 1.

As described above, a bridged portable internet system and a method of processing a signal thereof, according to the present invention, performs a simple and effective signaling process using a layer 2 bridge in a next-generation wireless edge network so that an effective and fast handover can be provided.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A bridged portable internet system, comprising:
a plurality of edge bridges entirely connected as a mesh structure to form a core network, and configured as a layer 2 switch;
a plurality of Radio Access Stations (RASs) connected to one of the plurality of edge bridges to provide portable internet services to Mobile Nodes (MNs) within the range of services; and
a Neighbor Discovery Server (NDS) to support neighbor discovery of components in the network and store and manage a configuration information of the components,
wherein each of the plurality of edge bridges maintains an optimal path through a predetermined routing protocol, identifies the destination of a Media Access Control (MAC) frame transmitted by an MN connected to an edge bridge itself through a corresponding RAS by referring to the configuration information from the NDS so as to transmit a corresponding MAC frame to the MAC address of an edge bridge to which a corresponding Correspondent Node (CN) is connected by performing MAC in MAC encapsulation if receiving a MAC in MAC encapsulated frame with its own MAC address as a destination, and performs MAC in MAC encapsulation with the frame to delete an outer MAC address and to transmit an original MAC frame to a corresponding MN.

2. The bridged portable internet system as claimed in claim 1, wherein the network is entirely configured as the core network and segment, and the core network and segment are mesh and tree structures, respectively.

3. The bridged portable internet system as claimed in claim 1, wherein the network is entirely configured as the core network and segment, and each of the core network and segment is a mesh structure.

4. The bridged portable internet system as claimed in claim 1, wherein the MN sends a registration request message to the NDS through the RAS and the edge bridge to register the address of the edge bridge connected to its own MAC address and its own Internet Protocol address in an initial connection, and the NDS stores and manages them in the configuration information.

5. A method for processing a signal of a bridged portable internet system that includes a plurality of edge bridges entirely connected as a mesh structure to form a core network, and configured as a layer 2 switch, a plurality of Radio Access Stations (RASs) connected to one of the plurality of edge bridges to provides portable internet services to Mobile Nodes (MNs) within the range of services, and a Neighbor Discovery Server (NDS) to support neighbor discovery of components in the network and to store and manage configuration information of the components, comprising the steps of:
the MN transmitting a predetermined registration request message to an edge bridge connected through a corresponding RAS in a state where an initial link with the RAS is formed;
the edge bridge, performing the steps of
receiving the registration request message through the RAS from the MN,
setting the frame destination address of the registration request message as an NDS, and
transmitting the frame destination address to the NDS by performing MAC in MAC encapsulation; and
the NDS, performing the steps of
receiving the registration request message of the MN from the edge bridge,
making the MAC address of a corresponding MN, the IDentifier (ID) of a corresponding relative edge bridge and the IP address of the corresponding MN into a table to store and/or update them.

6. The method as claimed in claim 5, further comprising the steps of:
a Correspondent Node (CN) intending to transmit data, transmitting the message “Neighbor Solicitation” to the NDS via a corresponding edge bridge so as to obtain the MAC address of an destination MN;
the NDS performing the steps of—
receiving the message “Neighbor Solicitation”,
transmitting the message “Neighbor Advertisement” comprising the MAC address of the corresponding destination MN to the CN via the corresponding edge bridge;
the CN performing the steps of—
obtaining the MAC address of the destination MN through the message “Neighbor Advertisement”,
transmitting a data frame to a corresponding edge bridge;
the edge bridge performing the steps of
receiving the data frame from the CN,
transmitting the data frame to the ID of the edge bridge to which the destination MN is connected by performing MAC in MAC encapsulation; and
an edge bridge corresponding to the BridgeID of the MAC in MAC encapsulated frame, performing the steps of
receiving the MAC in MAC encapsulated frame,
decapsulating the received MAC in MAC encapsulated frame,
providing the decapsulated frame to a corresponding MN.

7. The method as claimed in claim 6, wherein each of the edge bridges performs the steps of:
maintaining the MAC address of each MN and an own Bridge ID binding table in a soft state;
using a Bridge ID of a destination previously stored in the own table if a received MAC frame is to be transmitted to a specific MN;
obtaining the Bridge ID of a corresponding edge bridge through the NDS unless the Bridge ID of the destination is stored in the own table of the edge bridge, so as to transmit the MAC frame by performing MAC in MAC encapsulation.

8. The method as claimed in claim 7, further comprising the steps of:
a preliminary step of the NDS storing in the own table of the edge bridge, a Bridge ID list of an edge bridge of a CN for a specific MN in a case where the NDS receives an ID request message transmitted by each of the edge bridges;
in a case where the MN moves to the new edge bridge the MN performing the steps of—
forming a link with a new edge bridge,
sending a registration request message to the NDS through the newly linked edge bridge to register the Bridge ID of the new edge bridge connected to the MN itself; and
the NDS, which has received the registration request message, performing the steps of—
sending an update message containing the Bridge ID of the new edge bridge to an edge bridge corresponding to the Bridge ID of the CN that was previously stored in the list of a corresponding MN within an own table of the NDS, and
sending a Bridge ID update message containing the Bridge ID of the CN to the new edge bridge.
